(19) United States
(12) Patent Application Publication
(10) Pub. No.: US 2025/0347329 A1
(43) Pub. Date: Nov. 13, 2025

(54) BRAKE CALLIPER HOUSING FOR USE FOR AN ELECTROMECHANICALLY ACTUABLE BRAKE ACTUATOR

(71) Applicants: ZF Active Safety GmbH, Koblenz (DE); ZF Automotive Technologies (Shanghai) Co., Ltd, Shanghai (DE)

(72) Inventors: Florian Roessinger, Neuwied (DE); Lukas Madzgalla, Lahnstein (DE); Yi Cao, Shanghai (CN); Lian Wang, Dongyang (CN)

(73) Assignees: ZF Active Safety GmbH, Koblenz (DE); ZF Automotive Technologies (Shanghai) Co., Ltd, Shanghai (CN)

(21) Appl. No.: 19/201,988

(22) Filed: May 8, 2025

(30) Foreign Application Priority Data
May 8, 2024 (CN) 202410563542.3

(51) Int. Cl. F16D 65/00; B60T 13/74; F16D 55/00; F16D 65/18; F16D 125/00; F16D 125/40

(52) U.S. Cl. CPC F16D 65/0068; B60T 13/746; F16D 65/18; F16D 2055/0016; F16D 2125/00; F16D 2125/40; F16D 2250/00; F16D 2250/0069; F16D 2250/0084

(57) ABSTRACT

The present disclosure relates to a brake calliper housing for use for an electromechanically actuable brake actuator having a recess to accommodate a brake piston. The recess is delimited by a cylindrical recess wall, extending in an axial direction into the brake calliper housing, and by a recess bottom. The recess has a recess opening situated opposite the recess bottom. The brake calliper housing has a guide slot, let into the recess wall, to accommodate a guide element for securing the brake piston against rotation. The longitudinal extent of the guide slot runs parallel to the axial direction. The guide slot is of circular design in cross section.

### CROSS-REFERENCE TO RELATED APPLICATIONS

This application claims priority to China Patent Application No. 202410563542.3, filed May 8, 2024, the disclosure of which is incorporated herein by reference in its entirety.

### TECHNICAL FIELD

The present disclosure relates to a brake calliper housing for use for an electromechanically actuable brake actuator for a motor vehicle disc brake. In addition, the disclosure relates to an electromechanically actuable brake actuator for a motor vehicle disc brake having such a brake calliper housing and also to a motor vehicle disc brake having such a brake actuator. The disclosure furthermore relates to a production method for producing the brake calliper according to the disclosure.

### BACKGROUND

A brake calliper housing is a significant component of a motor vehicle disc brake. A brake actuator, which, in addition to the brake calliper housing, also comprises additional components, such as a brake piston and a brake piston drive, can be regarded as a subassembly of such a motor vehicle disc brake. Motor vehicle disc brakes in the form of floating calliper brakes are widely used, and these are given preferential consideration for the present disclosure, and the brake actuator according to the disclosure and the brake calliper housing according to the disclosure may be used in these floating calliper brakes.

Apart from hydraulically or pneumatically actuable brake actuators, the prior art also includes electromechanically actuable brake actuators and corresponding motor vehicle disc brakes and brake calliper housings. As is known, electromechanically actuable brake actuators are used to mount the brake piston, which is accommodated in a recess in a brake calliper housing, for axial movement and to make them available for actuation by electromechanical drive. This enables the brake piston to transfer an actuating force to brake pads which, in turn, press against a brake rotor with a contact force and can brake the latter.

Rotation-translation mechanisms are widely used to actuate the brake piston. Among known solutions is the use of recirculating ball screws, which have an electromechanically driven drive spindle and a rotationally secured spindle nut, such that the spindle nut is driven in translation and this movement and force are transferred to the brake piston.

One challenge in implementing such brake actuators, brake calliper housings and motor vehicle disc brakes is the configuration of the anti-rotation device for the spindle nut. The region where the brake piston or the spindle nut is arranged-in some prior-art embodiments, the brake piston and the spindle nut also form a unit-is generally difficult to access owing to the construction of the brake calliper housing or owing to the installation position of the brake piston in the brake calliper housing, with the result that prior-art anti-rotation devices are either of complex configuration or are relatively expensive to produce. A motor vehicle disc brake with an electromechanical brake actuator is disclosed in DE 10 2022 119 397 A1, for example.

### SUMMARY

What is needed is a brake calliper housing, an electromechanically actuable brake actuator for a motor vehicle disc brake and a corresponding motor vehicle disc brake on which an anti-rotation device that can be produced at low cost and works in a precise way. Moreover, the components which perform the function of safeguarding against rotation should withstand high and enduring mechanical stress. In addition, making the electromechanically actuable brake actuator and thus also an associated motor vehicle disc brake relatively easy to install is also needed. Moreover, a production method for producing the brake calliper housing according to the disclosure is also needed.

According to the disclosure, a brake calliper housing having the features of claim 1 is proposed. Further, a brake actuator having the features of claim 6 is also proposed. A motor vehicle disc brake having the features of claim 9 and a production method having the method steps of claim 10 are further proposed. Exemplary arrangements of the disclosure are indicated in the respective dependent claims 2 to 5, 7 to 8, and 11 to 13.

The brake calliper housing according to the disclosure is provided for use for an or in an electromechanically actuable brake actuator. The brake calliper housing has a recess to accommodate a brake piston. The recess is delimited by a cylindrical recess wall, extending in an axial direction into the brake calliper housing, and by a recess bottom, wherein the recess has a recess opening situated opposite the recess bottom. The brake calliper housing furthermore has a guide slot, let into the recess wall, to accommodate and guide a guide element for securing a brake piston against rotation, wherein the longitudinal extent of the guide slot runs parallel to the axial direction. The guide slot is of circular design in cross section. The circular design of the guide slot provides a slot wall with an appropriately shaped surface, against which an associated guide element can fit closely, e.g. a parallel key, leading, in turn, to precise guidance of such a guide element in the guide slot. Moreover, owing to the circular design of the guide slot, material stresses in the brake calliper housing are reduced, ensuring high durability of the brake calliper housing in this region. In addition, such a guide slot can be produced at low cost by a suitable production method.

The expression “axially” or in the “axial direction” refers to the direction of extent of the recess into the brake calliper housing and to the direction of movement of a brake piston, in the assembled state of the brake calliper housing in a brake actuator, in the direction of a brake disc associated therewith in the installed state of the brake actuator in a disc brake, or away from this brake disc. That is to say the axial direction runs transversely to the braking surfaces of an associated brake disc.

In one exemplary arrangement, the guide slot has a slot wall which reproduces the circular arc of a semicircle in cross section or which reproduces the circular arc of a circle segment of height h in cross section, wherein the height h is at least ⅓ the diameter of the circle associated with the circle segment. The height h may be at least 5/12 of the diameter of the circle associated with the circle segment. The abovementioned exemplary slot wall shapes ensure easy installation of a guide element in the guide slot and thus of an associated brake piston in the recess.

In one exemplary arrangement, the guide slot emerges from the brake calliper housing in the axial direction in the region of the recess opening, or the guide slot is delimited in the axial direction by the recess bottom or in the region of the recess bottom. In one exemplary configuration, both the emergence of the guide slot in the axial direction from the brake calliper housing in the region of the recess opening, and the delimitation of the guide slot in the axial direction by the recess bottom or in the region of the recess bottom, are achieved. That is to say, when considering the brake calliper from the outside along the axial direction, that is to say looking towards the recess opening or into the recess from the brake disc slot, the view into the guide slot is unobstructed, and it is possible to see the circular cross section of the slot wall from this direction of view. The fact that the guide slot is delimited in the axial direction by the recess bottom or in the region of the recess bottom means that the guide slot does not emerge there from the brake calliper housing, or is not closed there. This represents a solution which is relatively easy to produce and is thus advantageous in terms of cost. Moreover, this solution offers protection from dirt since no dirt can penetrate into the recess on the side on which the recess bottom is located, owing to the fact that the guide slot is closed there. This leads, in turn, to an increased precise operation of the brake actuator in the long term.

In one exemplary arrangement, the recess opening has a first annular recess offset to accommodate a first brake piston seal, wherein the inside diameter of the first recess offset is greater than the inside diameter of the recess wall and wherein the guide slot opens directly into the first recess offset. In one exemplary arrangement, the recess opening has a first annular recess offset to accommodate a first brake piston seal, wherein the inside diameter of the first recess offset is greater than the inside diameter of the recess wall. In this case, the recess opening has a second annular recess offset to accommodate a second brake piston seal, wherein the inside diameter of the second recess offset is greater than the inside diameter of the first recess offset, wherein the guide slot opens directly into the first recess offset, wherein the first and the second recess offset are arranged axially adjacent to one another, and wherein the first recess offset is situated deeper in the recess in the axial direction than the second recess offset. Both exemplary configuration options with the first recess offset or the first and the second recess offset serve to provide a low-cost and easily installed sealing system for sealing the brake piston and the recess.

In one exemplary arrangement, the brake calliper housing is of substantially mirror-symmetrical configuration with respect to a mirror plane, wherein the recess is configured and oriented concentrically around its own recess axis or axis of symmetry, wherein the axis of symmetry runs parallel to the axial direction and lies on the mirror plane, wherein the guide slot is configured and arranged in mirror symmetry with respect to the mirror plane. This configuration and arrangement of the guide slot is advantageous in respect of the production of the guide slot since good accessibility of the guide slot is ensured. This contributes to the reduction in costs. Moreover, the positioning contributes to easy installation of the brake actuator and, for example, of the guide element and of the piston.

The electromechanically actuable brake actuator according to the disclosure for a motor vehicle disc brake comprises a brake calliper housing according to one of the exemplary arrangements described above. It furthermore comprises a brake piston, which is mounted in an axially movable manner in the recess opening and has a piston wall that delimits the brake piston in a radial direction and an end wall that delimits the brake piston in the axial direction and that emerges from the recess opening. The brake actuator furthermore comprises a rotation-translation mechanism for driving the brake piston in translation, wherein the brake piston has a guide element, which protrudes outwards from the piston wall in the radial direction by a guiding portion. In this case, the guide element projects into the guide slot to secure the brake piston against rotation and can be moved in the axial direction relative to the guide slot. The rotation-translation mechanism may be configured as a nut-spindle mechanism and, in one exemplary arrangement, a recirculating ball screw. Owing to the configuration of the guide slot with its circular shape described above, the anti-rotation device described works precisely and, by virtue of the guide slot configuration and arrangement, is relatively easy to install together with the brake piston from the direction of the recess opening.

Where, for the sake of better readability, only the term “brake actuator” is mentioned in the present description of the disclosure, without the preceding words “electromechanically actuable”, this should always be understood to refer to an electromechanically actuable brake actuator.

In one exemplary arrangement, the guiding portion of the guide element is of at least partially circular design in a cross section transverse to the axial direction. In a further configuration, the guiding portion is of partially circular design in a cross section transverse to the axial direction in such a way that the guiding portion is flattened in the region oriented towards the slot base of the guide slot, and that the guiding portion is of circular design on both sides of this flat. For example, the second variant fits closely against the slot wall without play and yet in a manner that allows easy axial movement, leading to an anti-rotation device that works precisely. The flat is may be oriented orthogonally to the mirror plane, and the circular portions situated on both sides of this flat are preferably arranged in mirror symmetry with respect to the mirror plane. The brake piston has a piston wall, and the guide element can be connected to the piston wall by the following methods of attachment or the combination thereof: The piston wall has a depression into which the guide element is inserted. The piston wall has a depression into which the guide element is pressed. The piston wall has a depression into which the guide element is adhesively bonded. The guide element is screwed to the piston wall or to a depression in the piston wall. Alternatively, the guide element can be connected integrally to the piston wall.

In one exemplary arrangement of the brake actuator, the brake actuator has a first seal, for example a sealing ring, which is inserted into the first annular recess offset, wherein the first seal may be configured as a sealing ring having a sealing lip which fits closely against the brake piston, thus ensuring that the first seal seals the recess with respect to the environment, thus, for example, maintaining lubrication of the brake piston but also avoiding the entry of dirt into the brake piston guide.

In another exemplary arrangement of the brake actuator, the brake actuator has, in addition to the abovementioned first seal, a second seal, which is inserted in the second annular recess offset, wherein the second seal is a sealing gaiter, wherein the sealing gaiter is secured circumferentially on the brake piston, thus ensuring that the second seal seals the recess with respect to the environment, thus avoiding the entry of dirt into the recess.

The motor vehicle disc brake according to the disclosure comprises a brake carrier, an electromechanical drive, and a brake actuator according to one of the exemplary arrangements described above, which can be actuated by the electromechanical drive. Such a motor vehicle disc brake has each of the already mentioned features and advantages of the brake calliper housing according to the disclosure and of the brake actuator according to the disclosure.

The method according to the disclosure for at least partial production of a brake calliper housing according to one of the exemplary arrangements described above comprises the following method steps:
a) primary forming of a brake calliper housing blank or use of a brake calliper blank, in each case with a pre-formed recess, in which the wall thickness of the recess wall is at least partially thicker than in the finished brake calliper housing in such a way that the internal volume of the pre-formed recess is smaller than the internal volume of the recess in the finished brake calliper housing,
b) production of a bore in the recess wall, wherein the longitudinal axis of the bore runs parallel to the axial direction, wherein the depth of the bore is at least ½, and in one exemplary arrangement, at least ⅔, of the depth both of the pre-formed and of the finished recess or at least of the pre-formed or the finished recess,
and c) enlargement of the recess to the final dimensions by machining, such that the guide slot is formed by the removal of material from the bore.

This production method leads, for example, to very low-cost production of the guide slot and thus of the entire brake calliper housing and also of the higher-level assemblies. Production of a bore by machining is simple and inexpensive in comparison with complex machining operations that are necessary in the case of prior-art solutions.

A casting method, for example, a diecasting method, or alternatively a 3D printing method are exemplary methods for consideration for the method step of primary forming.

In method step b), the bore may be introduced into the recess wall in the direction of the recess bottom from the side on which the recess opening is located. The bore is a blind bore. A blind bore is inexpensive to produce per se, and only as much material as necessary has to be machined away. The bore can be introduced easily from the side on which the recess opening is located since, in this region, there are easily accessible regions. This likewise contributes to low-cost manufacture.

In one exemplary configuration of the production method, the method described above comprises the following additional method steps:
d) production of the first annular recess offset, or
e) production of the first annular recess offset and production of the second annular recess offset.

In an alternative variant of the production method, the sequence of method steps is a), then d) or e), then b), then c). d).

### BRIEF DESCRIPTION OF THE DRAWINGS

Further features, advantages and possible uses of the present disclosure will become apparent from the following description of the exemplary arrangements and schematic FIGS. 1 to 8. For the sake of clarity, not all the elements illustrated in a figure are also provided with a reference sign in all cases. However, corresponding elements or regions are then at least indicated in some other figure, and the significance can be taken from there. Moreover, it is also possible in the figures for the same reference signs to stand for the same or similar objects.

FIG. 1 shows one exemplary arrangement of the brake calliper housing according to the disclosure in section, and therefore the bridge and the brake fingers are not illustrated;

FIG. 2 shows one exemplary arrangement of the brake actuator according to the disclosure;

FIG. 3 shows the same exemplary arrangement of the brake actuator according to the disclosure without seals;

FIG. 4 shows a detail of the illustration shown in FIG. 3;

FIG. 5 shows one exemplary arrangement of the motor vehicle disc brake according to the disclosure;

FIG. 6 shows a brake calliper housing according to the disclosure in one production stage of a brake calliper housing blank;

FIG. 7 shows a brake calliper housing according to the disclosure in another production stage of a brake calliper housing blank; and

FIG. 8 shows a brake calliper housing according to the disclosure in the finished form.

### DETAILED DESCRIPTION

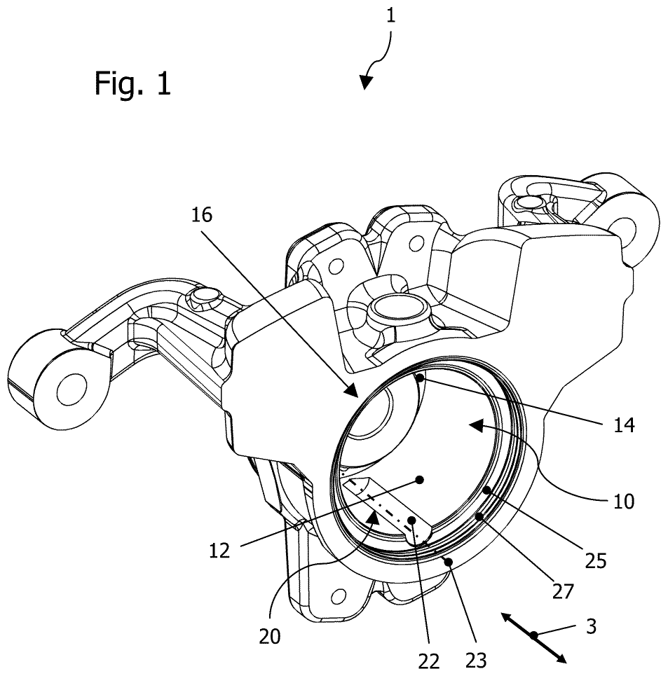

FIG. 1 illustrates one example of a brake calliper housing 1 according to the disclosure in section, thus giving a view of the recess 10 which serves to accommodate and guide the brake piston. Owing to the sectional illustration, the bridge of the brake calliper housing 1 and the brake fingers thereof are not illustrated.

The cylindrical recess 10 runs parallel to the axial direction 3 into the brake calliper housing 1. The recess 10 is delimited by a cylindrical recess wall 12 and, at the bottom, by a recess bottom 14. On the opposite side from the recess bottom 14, i.e. towards the observer, the recess 10 is open. That is to say, there is there a recess opening 16, from which an associated brake piston 50 emerges, or can be extended.

A guide slot 20 is let into the recess wall 12, or the recess wall 12 is correspondingly hollowed out in this region. Starting from the recess opening 16, the guide slot 20 extends in the axial direction 3 into the recess 10 and ends in the region of the recess bottom 14. To be more precise, the recess bottom 14 has a bottom surface directed towards the recess 10 and a projection that projects into the recess 10 from the bottom surface. The guide slot 20 extends almost as far as the bottom surface but does not penetrate the recess bottom 14.

In the region of the recess opening 16, the recess 10 has a first annular recess offset 25, which enlarges the diameter of the recess 10, and a second annular recess offset 27, which enlarges the diameter of the recess 10 even further relative to the first recess offset 25 and which opens into an outer surface of the brake calliper housing 1. Thus, the first recess offset 25 is situated axially between the recess wall 12 and the second recess offset 27. As a result, a disc-shaped contact surface, which is oriented orthogonally to the axial direction 3 and from which the guide slot 20 emerges, is formed at the transition between the recess wall 12 and the first recess offset 25. The first recess offset 25 serves to accommodate a seal, for example, a sealing ring, and the second recess offset 27 serves to accommodate a second seal, for example, a sealing gaiter.

When viewed in cross section, the guide slot 20 has a circular slot wall 22, i.e. the lateral slot walls and the slot base merge into one another and form a cylindrical surface. The brake calliper housing 1 is of mirror-symmetrical configuration with respect to a mirror plane 6. The mirror plane 6 runs through and is thus congruent with the axis of symmetry 11 of the recess 10. On account of its circular profile, the guide slot 20 has a guide slot axis 23 with which at least the circular slot wall 22 of the guide slot 20 is concentrically shaped. The guide slot axis 23 runs parallel to the axis of symmetry 11 and is congruent with the mirror plane 6. This position and alignment of the guide slot 20 enables low-cost production and relatively easy installation of an associated brake piston 50 with an associated guide element 60, which will be described in greater detail below in combination with the brake actuator 50.

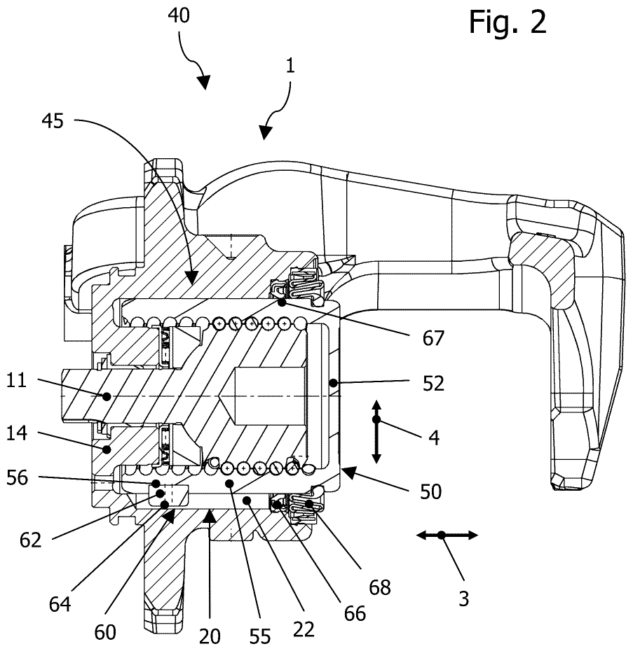

FIG. 2 shows an exemplary arrangement of a brake actuator 40 according to the disclosure. A brake piston 50 is mounted in an axially movable manner in the recess 10. The brake piston 50 has a cylindrical piston wall 55 and an end wall 52, which protrudes somewhat from the brake calliper housing 1 through the recess opening 16. Here, the brake piston 50 is illustrated in a retracted position. When the brake actuator 40 is actuated, the brake piston 50 is moved in translation further out of the recess 10 in the direction of the brake disc slot, and it is therefore possible in this way, in an installed state, to transfer a force to brake pads.

The brake piston 50 is sealed by a first seal 66, which is designed as a sealing ring with a sealing lip 67 that fits closely against the piston wall 55 and which is inserted into the first recess offset 25. A second seal 68, which may be embodied as a sealing gaiter with a variable length sealing bellows, is inserted into the second recess offset 27 and is secured circumferentially on the brake piston 50 in the region behind the end wall 52. It seals the brake piston 50 and the recess 10 from the environment, for example, against dirt.

In the interior of the brake piston 50 there is a recirculating ball screw 45 with a rotatable spindle, balls and corresponding ball guides. In the exemplary arrangement, the spindle nut and the brake piston 50 form a unit. Among other things, this results in cost advantages on account of the reduction in parts and easier installation. However, other rotation-translation mechanisms could be used in combination with the disclosure. The drive shaft of the spindle passes through an aperture situated in the recess bottom 14.

In the piston wall 55 there is a depression 56, into which a guide element 60 is inserted. The guide element 60 protrudes outwards from the piston wall 55 by a guiding portion 62 in a radial direction 4, which runs orthogonally to the axial direction 3, with the result that it projects into the guide slot 20.

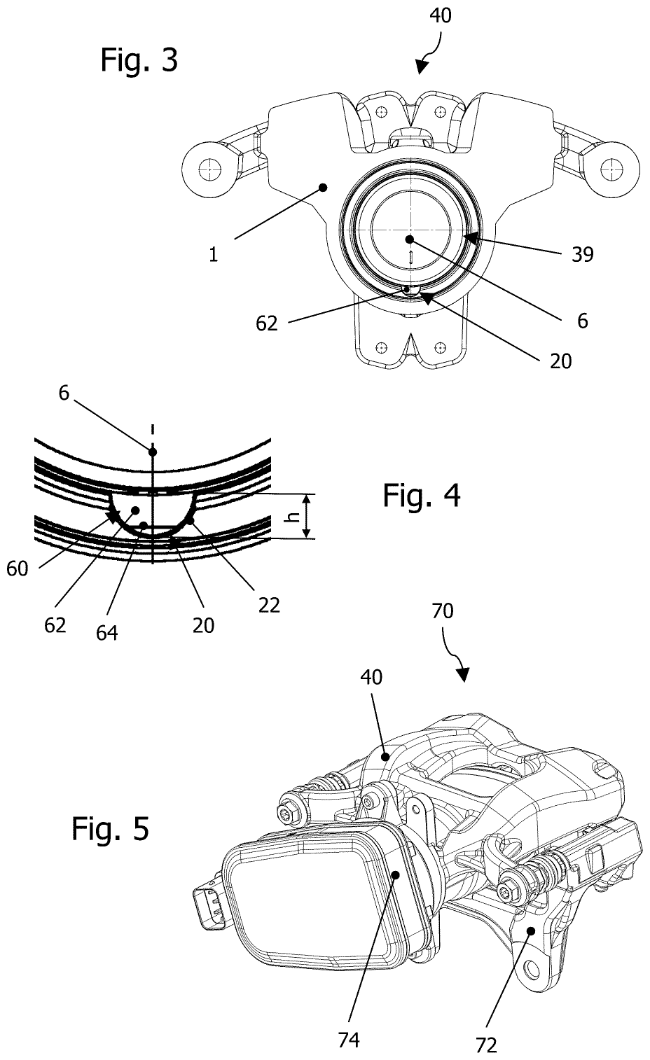

The guide slot 20, the guide element 60 and the dependency of the action of the two elements is described in greater detail below with reference to FIGS. 3 and 4. Here, the brake actuator 40 is illustrated such that the direction of view runs parallel to the axial direction 3 and the view falls on the end wall 52 from the outside. The brake actuator 40 is illustrated without the seals 66 and 68, and therefore the guide slot 20 is visible in cross section, and the guide element 60 is visible. When viewed in cross section, the slot wall 22 of the guide slot 20 forms a circle segment of height h. The guide slot 20 is arranged and configured in mirror symmetry with respect to the mirror plane 6. The guide element 60 is inserted into the piston wall 55 of the brake piston 50 and projects by its guiding portion 62 into the guide slot 20 in such a way that the guide element 60 and thus also the brake piston 50 are guided in a manner secured against rotation and with the ability for axial movement. When viewed in cross section, the guiding portion 62 has, in the region which projects into the guide slot 20, two circular wall portions, which are arranged at a distance from one another in mirror symmetry with respect to the mirror plane 6 and are connected to one another by a flattened, planar wall portion. Where the flattened wall region is situated, the guide element 60 has no contact with the slot wall 22, while the two circular wall portions of the guiding portion 62 are in contact with the slot wall 22, thereby securing the brake piston 50 against rotation. The configuration of the corresponding contact surfaces with a circular shape and also the configuration of the two mutually spaced circular wall surfaces of the guiding portion 62 result in anti-rotation device which works precisely. Moreover, the circular contact surfaces reduce material stresses both in the guide element 60 and in the piston wall 55, allowing long-term mechanical stressing of the brake actuator 40. Furthermore, relatively easy installation of the brake piston 50 in the brake calliper housing 1 is also obtained.

FIG. 5 shows one exemplary arrangement of the motor vehicle disc brake 70 according to the disclosure. The brake actuator 40 is coupled in an axially movable manner, by two guide pins guided in corresponding guide bores, to a brake carrier 72, which can be connected rigidly to the chassis of a motor vehicle. The motor vehicle disc brake 70 has an electromechanical drive 74, which is connected in terms of drive to the recirculating ball screw 45 of the brake actuator 40. Ultimately, the already described configuration features of the brake calliper housing 1 and of the brake actuator 40 also contribute to a low-cost and easily installed motor vehicle disc brake 70.

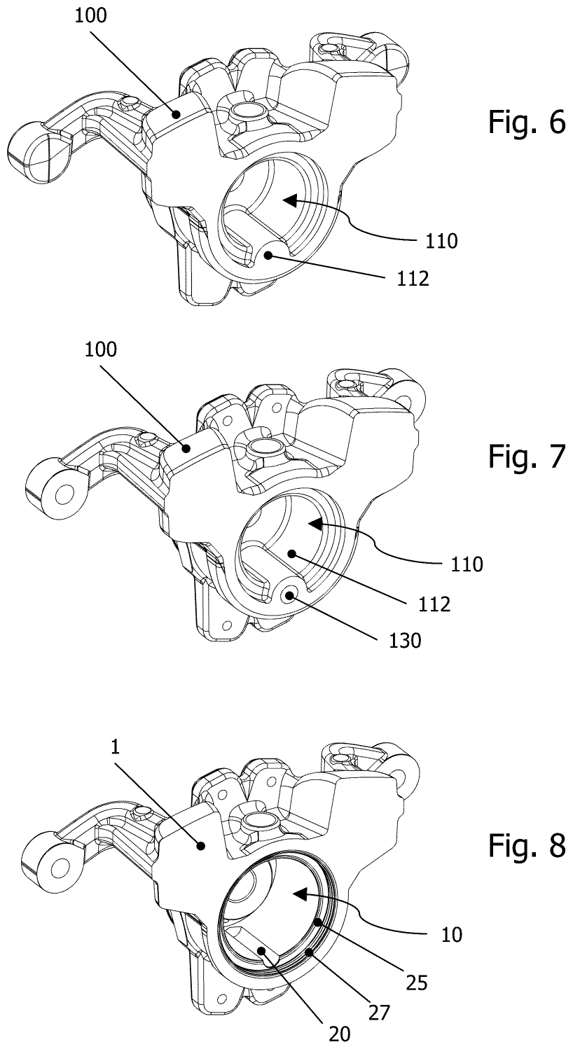

The production method according to the disclosure for at least partially producing the brake calliper housing 1 according to the disclosure is explained by way of example with reference to FIGS. 6 to 8.

In FIG. 6, the brake calliper housing 1 is shown as a brake calliper housing blank 100. The fact that the brake calliper housing 1 and the brake calliper housing blank 100 are provided with different reference signs serves to clarify the production method. However, the brake calliper housing 1 and the brake calliper housing blank 100 are the same component, each merely being in a different production state. This applies likewise to the recess 10 (pre-formed recess 110), the recess wall 12 (112) and the guide slot 20 (bore 120). The brake calliper housing blank 100 is a diecast component and has a pre-formed recess 110. The pre-formed recess 110 has a smaller volume than the recess 10 of the finished brake calliper housing 1. This stems from the fact that, particularly in the region in which the guide slot 20 is located in a subsequent production step, the recess wall 112 is thicker. However, even in the remaining region of the pre-formed recess 110, the recess wall 112 in this production stage is thicker, and therefore the pre-formed recess 110 also has a smaller inside diameter than the recess 10 in the finished state of the brake calliper housing 1. The production stage illustrated in FIG. 6 is the result of a first production step a), according to which the brake calliper housing blank 100 has been produced by primary forming (in this case diecasting). At this stage, the brake calliper housing blank 100 already has its essential geometrical basic shape.

In a further method step b), which is illustrated in FIG. 7, a blind bore 120 is introduced into the recess wall 112. Starting from the side of the brake calliper housing 1 on which the recess opening 16 is situated, the bore 120 extends into the recess wall 112. The longitudinal axis of the bore 120 runs parallel to the axis of symmetry 11 of the pre-formed recess 110. The production of such a blind bore 120 is inexpensive. Since, in this production stage, the recess wall 112 still has a wall thickness such that the bore 120 can be borrowed into the solid material, a precise parallel path of the bore 120 is also ensured. In this method step b), further bores, e.g. fastening bores for fastening guide pins, or similar machined features can be introduced into the brake calliper housing.

In FIG. 8, the brake calliper housing 1 is finished at least to the extent that the recess 10, the guide slot 20 and two annular recess offsets 25, 27 have been finished. In the corresponding method step, the pre-formed recess 110 and the recess offsets 25, 27 are finish-bored, for example, with material therefore also being removed in the region of the bore 120. Due to this removal, the guide slot 20 in the final form already described is formed or laid bare. The material in the pre-formed recess 110 could also be removed, for example, by an alternative machining method, e.g. by milling. Overall, the brake calliper housing 1 according to the disclosure can be produced at low cost by the method described above.

1. A brake calliper housing for use for an electromechanically actuable brake actuator comprising a recess accommodate a brake piston, which recess is delimited by a cylindrical recess wall, extending in an axial direction into the brake calliper housing, and by a recess bottom, wherein the recess has a recess opening situated opposite the recess bottom, wherein the brake calliper housing has a guide slot let into the recess wall to accommodate a guide element for securing the brake piston against rotation, wherein the a longitudinal extent of the guide slot runs parallel to the axial direction, wherein guide slot is of circular design in cross section.

2. The brake calliper housing according to claim 1, wherein the guide slot has a slot wall which reproduces the circular arc of a semicircle in cross section or which reproduces the circular arc of a circle segment of height in cross section, wherein the height is at least ⅓ the diameter of the circle associated with the circle segment.

3. The brake calliper housing according to claim 1, wherein the guide slot emerges from the brake calliper housing in an axial direction in a region of the recess opening.

4. The brake calliper housing according to claim 1. wherein the recess opening has a first annular recess offset to accommodate a first brake piston seal, wherein an inside diameter of the first annular recess offset is greater than an inside diameter of the recess wall and wherein the guide slot opens directly into the first annular recess offset.

5. The brake calliper housing according to claim 1, wherein the brake calliper housing is of substantially mirror-symmetrical configuration with respect to a mirror plane, wherein the recess is configured and oriented concentrically around its own axis of symmetry, wherein the axis of symmetry runs parallel to the axial direction and lies on the mirror plane, wherein the guide slot is configured and arranged in mirror symmetry with respect to the mirror plane.

6. A electromechanically actuable brake actuator for a motor vehicle disc brake comprising:
a brake calliper housing according to claim 1,
a brake piston mounted in an axially movable manner in the recess opening and has a piston wall that delimits the brake piston in a radial direction and an end wall that delimits the brake piston in the axial direction and that emerges from the recess opening,
a rotation-translation mechanism for driving the brake piston translation, wherein the brake piston has a guide element, which protrudes outwards from the piston wall in the radial direction by a guiding portion, wherein the guide element projects into the guide slot to secure the brake piston against rotation and can be moved in an axial direction relative to the guide slot.

7. The electromechanically actuable brake actuator according to claim 6, wherein the guiding portion of the guide element is of at least partially circular design in a cross section transverse to the axial direction, and/or wherein the guiding portion is of partially circular design in a cross section transverse to the axial direction in such a way that the guiding portion is flattened in the region oriented towards the slot base of the guide slot, and that the guiding portion is of circular design on both sides of this flat.

8. The electromechanically actuable brake actuator according to claim 6,
wherein the piston wall has a depression into which the guide element is inserted, and/or
wherein the piston wall has a depression into which the guide element is pressed, and/or
wherein the piston wall has a depression into which the guide element is adhesively bonded, and/or
wherein the guide element is screwed to the piston wall or to a depression in the piston wall.

9. The electromechanically actuable brake actuator to one claim 6, wherein the brake actuator has a first seal, which is accommodated in a first annular recess offset, and/or wherein the brake actuator has a second seal, which is accommodated in a second annular recess offset.

10. A motor vehicle disc brake comprising a brake carrier, an electromechanical drive, and a brake actuator according to claim 6, which can be actuated by the electromechanical drive.

11. A method for at least partial production of a brake calliper housing according to claim 1, comprising the following method steps:
a) primary forming of a brake calliper housing blank with a pre-formed recess, in which the wall thickness of the recess wall is at least partially thicker in the finished brake calliper housing in such a way that an internal volume of the pre-formed recess is smaller than the internal volume of the recess in the finished brake calliper housing,
b) production of a bore in the recess wall, wherein longitudinal axis of the bore runs parallel to the axial direction, wherein the depth of the bore is at least ½, of a depth of the pre-formed and/or the finished recess.
c) enlargement of the pre-formed recess to the final dimensions by machining, such that the guide slot is formed by the removal of material from the bore

12. The method according to claim 11, wherein, in method step b), the bore is introduced into the recess wall in the direction of the recess bottom from a side on which the recess opening is located, and/or wherein the bore is a blind bore.

13. The method according to claim 11 with the following additional method step:
d) production of the first annular recess offset, or
e) production of the first annular recess offset and production of the second annular recess offset.

14. The method according to claim 13, wherein the sequence of method steps is step a); then step d) or step e); then step b); then c).

15. The brake calliper housing according to claim 1, wherein the guide slot is delimited in the axial direction by the recess bottom or in the region of the recess bottom.

16. The brake calliper housing according to claim 1, wherein the recess opening has a first annular recess offset to accommodate a first brake piston seal, wherein the inside diameter of the first annular recess offset is greater than the inside diameter of the recess wall and wherein the recess opening has a second annular recess offset to accommodate a second brake piston seal, wherein the inside diameter of the second annular recess offset is greater than the inside diameter of the first annular recess offset, wherein the guide slot opens directly into the first annular recess offset, wherein the first and the second annular recess offsets are arranged axially adjacent to one another, and wherein the first annular recess offset is situated deeper in the recess in the axial direction than the second annular recess offset.
